(19) United States
(12) Patent Application Publication
(10) Pub. No.: US 2025/0294450 A1
(43) Pub. Date: Sep. 18, 2025

(54) SEAMLESS TRANSITION PROCEDURES FOR ACCESS POINT POWER SAVE

(71) Applicant: Cisco Technology, Inc., San Jose, CA (US)

(72) Inventors: Binita GUPTA, San Diego, CA (US); Brian D. HART, Sunnyvale, CA (US)

(21) Appl. No.: 19/077,409

(22) Filed: Mar. 12, 2025

Related U.S. Application Data
(60) Provisional application No. 63/564,289, filed on Mar. 12, 2024.

(51) Int. Cl. H04W 52/02; H04W 76/15

(52) U.S. Cl. CPC H04W 52/0216; H04W 76/15

(57) ABSTRACT

Techniques and apparatus for facilitating seamless transition of communications within a wireless network during access point (AP) power save operations are described. An example technique includes transmitting a power save schedule for the first AP MLD to a client MLD. The power save schedule indicates time period(s) during which the first AP MLD will perform an AP power save operation. An AP power save notification for the first AP MLD is transmitted to the client MLD and indicates an amount of time after which the first AP MLD will perform the AP power save operation. A determination is made that the client MLD is connected to the first AP MLD within a predetermined amount of time of the AP power save operation. In response to the determination, link(s) for the client MLD are set up on the second AP MLD prior to the AP power save operation.

### CROSS-REFERENCE TO RELATED APPLICATIONS

This application claims benefit of co-pending U.S. Provisional Patent Application Ser. No. 63/564,289 filed Mar. 12, 2024. The aforementioned related patent application is herein incorporated by reference in its entirety.

### TECHNICAL FIELD

Embodiments presented in this disclosure generally relate to wireless communications. More specifically, embodiments disclosed herein relate to techniques for facilitating seamless transition of communications within a wireless communication network during access point (AP) power save operations.

### BACKGROUND

Wireless communication standards, such as the Institute of Electrical and Electronics Engineers (IEEE) 802.11 technical standard, are continuing to evolve to meet the ever increasing demands of bandwidth intensive and low latency services. Recent amendments to IEEE 802.11 (e.g., IEEE 802.11be amendment and later amendments) aim to introduce higher data rates using higher modulation orders, larger channel widths, and additional spatial streams, as well as a set of new features such as multi-link operation (MLO), as an illustrative example.

MLO enables multi-link devices (MLDs), such as access points (AP) MLDs and station (STA) MLDs (also referred to as non-AP MLDs), to simultaneously send and receive data across different frequency bands and channels. With MLO, multiple links can be established between the STA MLD and the same or different AP MLD to increase throughput, reduce latency, and improve reliability. MLO thus enables a multi-link AP logical entity (e.g., AP MLD) and a multi-link non-AP logical entity (e.g., STA MLD or non-AP MLD) to use multiple paths for user plane traffic.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 illustrates an example system, according to certain embodiments.

FIG. 2 illustrates an example architecture of a multi-link device, according to certain embodiments.

FIG. 3 illustrates an example call flow for seamless transition of communications during AP MLD power save operations, according to certain embodiments.

FIG. 4 illustrates another example call flow for seamless transition of communications during AP MLD power save operations, according to certain embodiments.

FIG. 5 illustrates another example call flow for seamless transition of communications during AP MLD power save operations, according to certain embodiments.

FIG. 6 is a flowchart of a method for seamless transition of communications

during AP MLD power save operations, according to certain embodiments.

FIG. 7 is a flowchart of another method for seamless transition of communications during AP MLD power save operations, according to certain embodiments.

FIG. 8 illustrates an example computing device, according to certain embodiments.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

One embodiment described herein is a computer-implemented method for wireless communications performed by a client multilink device (MLD). The computer-implemented method includes receiving, from a first access point (AP) MLD, a power save schedule for the first AP MLD. The power save schedule indicates one or more time periods during which the first AP MLD will perform an AP power save operation. The computer-implemented method also includes, in response to the power save schedule, determining to connect to a second AP MLD. The computer-implemented method further includes performing communications with the second AP MLD.

Another embodiment described herein is a client multilink device (MLD). The client MLD includes one or more memories collectively storing instructions, and one or more processors communicatively coupled to the one or more memories. The one or more processors are individually or collectively configured to execute the instructions to cause the client MLD to perform an operation. The operation includes receiving, from a first access point (AP) MLD, a power save schedule for the first AP MLD. The power save schedule indicates one or more time periods during which the first AP MLD will perform an AP power save operation. The operation also includes, in response to the power save schedule, determining to connect to a second AP MLD. The operation further includes performing communications with the second AP MLD.

Another embodiment described herein is a non-transitory computer-readable medium. The non-transitory computer-readable medium includes computer-executable code, which when executed by one or more processors of a client multilink device (MLD) perform an operation. The operation includes receiving, from a first access point (AP) MLD, a power save schedule for the first AP MLD. The power save schedule indicates one or more time periods during which the first AP MLD will perform an AP power save operation. The operation also includes, in response to the power save schedule, determining to connect to a second AP MLD. The operation further includes performing communications with the second AP MLD.

Another embodiment described herein is a computer-implemented method for wireless communications performed by a first access point (AP) multilink device (MLD). The computer-implemented method includes transmitting a power save schedule for the first AP MLD to at least a client MLD. The power save schedule indicates one or more time periods during which the first AP MLD will perform an AP power save operation. The computer-implemented method also includes transmitting an AP power save notification for the first AP MLD to at least the client MLD. The AP power save notification indicates an amount of time after which the first AP MLD will perform the AP power save operation. The computer-implemented method also includes determining that the client MLD is connected to the first AP MLD within a predetermined amount of time of the AP power save operation. The computer-implemented method further includes in response to the determination, setting up a first one or more links for the client MLD on a second AP MLD prior to performing the AP power save operation.

Another embodiment described herein is a first access point (AP) multilink device (MLD). The first AP MLD includes one or more memories collectively storing instructions, and one or more processors communicatively coupled to the one or more memories. The one or more processors are individually or collectively configured to execute the instructions to cause the first AP MLD to perform an operation. The operation includes transmitting a power save schedule for the first AP MLD to at least a client MLD. The power save schedule indicates one or more time periods during which the first AP MLD will perform an AP power save operation. The operation also includes transmitting an AP power save notification for the first AP MLD to at least the client MLD. The AP power save notification indicates an amount of time after which the first AP MLD will perform the AP power save operation. The operation also includes determining that the client MLD is connected to the first AP MLD within a predetermined amount of time of the AP power save operation. The operation further includes in response to the determination, setting up one or more links for the client MLD on a second AP MLD prior to performing the AP power save operation.

Another embodiment described herein is a non-transitory computer-readable medium. The non-transitory computer-readable medium includes computer-executable code, which when executed by one or more processors of a first access point (AP) multilink device (MLD) perform an operation. The operation includes transmitting a power save schedule for the first AP MLD to at least a client MLD. The power save schedule indicates one or more time periods during which the first AP MLD will perform an AP power save operation. The operation also includes transmitting an AP power save notification for the first AP MLD to at least the client MLD. The AP power save notification indicates an amount of time after which the first AP MLD will perform the AP power save operation. The operation also includes determining that the client MLD is connected to the first AP MLD within a predetermined amount of time of the AP power save operation. The operation further includes in response to the determination, setting up one or more links for the client MLD on a second AP MLD prior to performing the AP power save operation.

### Example Embodiments

Certain wireless systems (e.g., IEEE 802.11be and later) may support a variety of different enhanced features to provide higher data rates, reduced latency, and other performance benefits. However, while such features have allowed for faster transmission rates, the emergence of faster transmission rates has generally resulted in increased AP densities within a given environment. In enterprise deployments, for example, there can be several AP MLDs (e.g., tens of AP MLDs, hundreds of AP MLDs, or more) deployed in a given area (e.g., floor, building, etc.).

In many scenarios, however, there may be times where a significant number of the AP MLDs deployed in the environment either have a few active client devices associated or do not have any client devices associated. That is, in such scenarios, the presence of client devices connecting to these AP MLDs may be sparse, such as on work-from-home days, as an illustrative example. In cases of sparse connectivity of clients, not all AP MLDs need to be active and providing connectivity all the time. Instead, some of the AP MLDs can be powered down for some duration of time, e.g., to save power and minimize energy consumption.

However, in some cases, AP MLD power save operations can impact the overall communication performance of the network. For example, powering off (or at least reducing the power of) one or more AP MLDs deployed within an environment can impact the communication performance of connected (or associated) clients in terms of lower throughput, dropped packets, increased latency, and lower transmission range, as illustrative, non-limiting examples. For example, clients that are still connected to an AP MLD when the AP MLD is powered down may lose their wireless connectivity, impacting the communication performance of the clients. Given that an AP MLD may be powered down based on a planned schedule or an impromptu schedule (e.g., an unplanned power down), it may be desirable to provide techniques that allow for the wireless network to maintain communication performance of clients connected to such AP MLDs.

Certain embodiments described herein provide techniques, systems, and apparatus for facilitating seamless transition of communications within a wireless network during AP MLD power save operations. The techniques described herein can be used to reduce the impact to a client's communication performance when one or more AP MLDs are powered down. In certain embodiments, a first AP MLD notifies clients (e.g., STA MLDs) in advance that the first AP MLD will be undergoing an AP MLD power save operation. As used herein, an AP MLD power save operation may refer to the AP MLD being powered down (e.g., the AP MLD is turned off), the AP MLD entering a reduced power state (e.g., the power to the AP MLD is reduced but not turned off), the AP MLD operating at a reduced capability (e.g., the AP MLD supports a reduced number of capabilities compared to when the AP MLD is not operating at a reduced capability). The first AP MLD may send the AP MLD power save notification in broadcast frames, multicast frames, unicast frames, or any combination thereof.

In certain embodiments, a client (e.g., STA MLD) uses the AP MLD power save notification to determine that the client should connect to a second AP MLD before the first AP MLD undergoes the AP MLD power save operation. In some examples, the client may be currently associated with the first AP MLD. In other examples, the client may not be currently associated with the first AP MLD, but may be searching for an AP MLD to (re)associate with within the communication network. In response to such a determination, the client may (re)initiate connection with the second AP MLD, e.g., to avoid losing connectivity.

In certain embodiments, after the first AP MLD sends an AP MLD power save notification, some clients may still be connected with the first AP MLD when the first AP MLD is about to undergo the AP MLD power save operation (e.g., some clients may still be connected with the first AP MLD within a predetermined amount of time of an initiation of the AP MLD power save operation). In such embodiments, the first AP MLD may coordinate with one or more neighboring AP MLDs, including the second AP MLD, to transfer setup links for these clients to the one or more neighboring AP MLDs. For example, if a client has a first link (e.g., 2.4 gigahertz (GHZ) link) on the first AP MLD and a second link (e.g., 5 GHZ link) on the second AP MLD, then the first AP MLD may coordinate with a neighboring AP MLD(s) to set up a third link (e.g., 2.4 GHZ) having similar parameters/metrics (e.g., bandwidth, frequency, latency, etc.) as the first link on one of the neighboring AP MLD(s) and set up a fourth link (e.g., 5 GHz link) having similar parameters as the third link on one of the neighboring AP MLD(s). By facilitating the transfer of setup links for clients to neighboring AP MLD(s), the first AP MLD can enable seamless transition of communications for such clients among AP MLD(s) (e.g., smooth and continuous roaming with no apparent interruption in data communication) during AP MLD power save operations and significantly improve a client's wireless performance in terms of increased throughput, reduced latency, and higher range, as illustrative, non-limiting examples.

Although the terms “first,” “second,” “third,” etc., may be used herein to describe various elements, components, regions, layers and/or sections, these elements, components, regions, layers and/or sections should not be limited by these terms. These terms may be only used to distinguish one element, component, region, layer or section from another element, component, region, layer, or section. Terms such as “first,” “second,” and other numerical terms, when used herein, do not imply a sequence or order unless clearly indicated by the context. Thus, a first element, component, region, layer, or section discussed herein could be termed a second element, component, region, layer, or section without departing from the teachings of the example embodiments.

As used herein, a hyphenated form of a reference numeral refers to a specific instance of an element and the un-hyphenated form of the reference numeral refers to the collective element. Thus, for example, device “12-1” refers to an instance of a device class, which may be referred to collectively as devices “12” and any one of which may be referred to generically as a device “12”. As used herein, the terms “carrier,” “subcarrier,” “frequency channel,” “channel unit,” “channel,” and “tone” may be used interchangeably to refer to a frequency unit (or unit of frequency).

Note, the techniques described herein for facilitating seamless transition of communications within a wireless network during AP MLD power save operations may be incorporated into (such as implemented within or performed by) a variety of wired or wireless apparatuses (such as nodes). In some implementations, a node includes a wireless node. Such wireless nodes may provide, for example, connectivity to or from a network (such as a wide area network (WAN) such as the Internet or a cellular network) via a wired or wireless communication link. In some implementations, a wireless node may include an AP MLD, a controller, or a STA MLD.

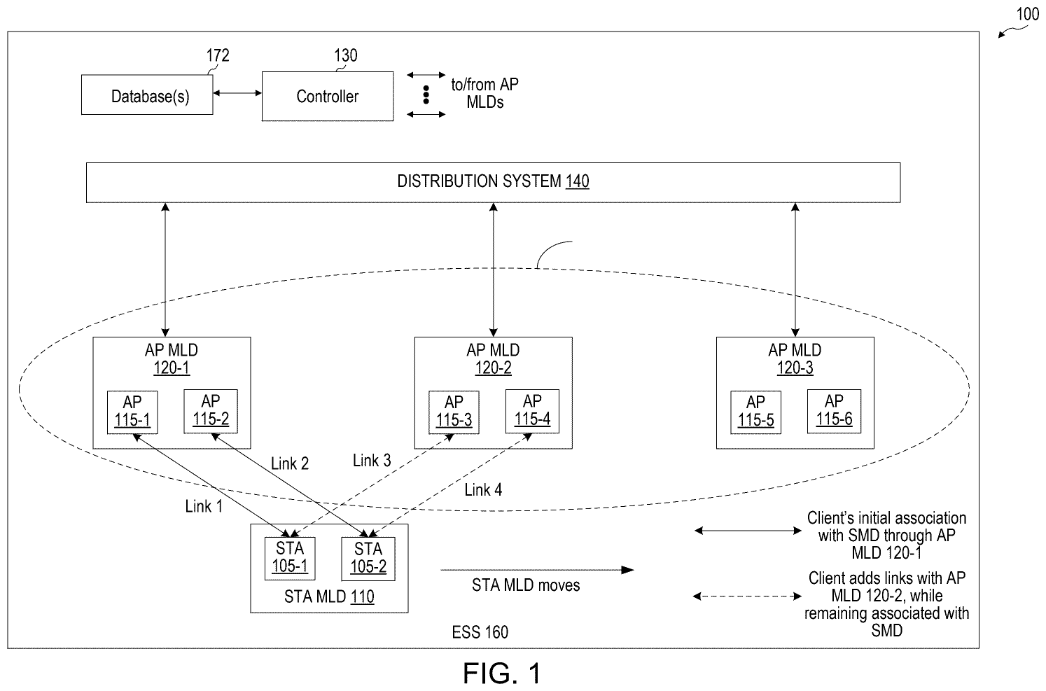

FIG. 1 illustrates an example system 100 in which one or more techniques described herein can be implemented, according to certain embodiments. As shown, the system 100 includes, without limitation, an extended service set (ESS) 160 (e.g., a wireless network, such as a campus/ESS network), which includes one or more basic service sets (BSSs) (not shown). ESS 160 includes, without limitation, one or more AP MLDs 120 (e.g., AP MLD 120-1, AP MLD 120-2, and AP MLD 120-3), a STA MLD 110, a distribution system (DS) 140, a controller 130, and one or more databases 172.

In certain embodiments, the ESS 160 is represented by a seamless mobility domain (SMD) 170. In such embodiments, the AP MLDs 120 may be included within (or otherwise associated with) the SMD 170. As used herein, a SMD refers to a logical entity to which a STA MLD associates, defines a set of AP MLDs within the same ESS that coordinate with each other to support seamless roaming between themselves, and that is identified by an SMD medium access control (MAC) address. As described further herein, a SMD may be used to support seamless roaming by one or more clients among one or more AP MLDs 120 within the SMD. For example, to support seamless roaming/mobility within the ESS 160, the STA MLD 110 can create association with the ESS 160 (represented by SMD 170) instead of with an individual AP or AP MLD (having multiple APs). In this manner, a STA MLD can roam seamlessly between AP MLDs without requiring (re)association and (re)establishment of contexts with each new AP MLD.

An AP MLD is generally a fixed station that communicates with STA MLD(s) and may be referred to as a base station, a MLD, a network entity, a wireless device, or some other terminology. A STA MLD may be fixed or mobile and also may be referred to as a mobile STA MLD, a client MLD, a MLD, a client STA MLD, a non-AP MLD, a client, a wireless device, or some other terminology. Note that while a certain number of AP MLDs and STA MLDs are depicted, the system 100 may include any number of AP MLDs and STA MLDs.

As used herein, an AP MLD along with the STA MLDs associated with the AP MLD (e.g., within the coverage area (or cell) of the AP MLD) may be referred to as a BSS. The AP MLD 120-1, AP 120-2, and AP 120-3 may be neighboring (peer) AP MLDs. The AP MLDs 120 may communicate with one or more STA MLDs 110 on the downlink and uplink. The downlink (e.g., forward link(s)) is the communication link(s) from the AP 120 MLD to the STA MLD(s) 110, and the uplink (e.g., reverse link(s)) is the communication link(s) from the STA MLD(s) 110 to the AP 120. In some cases, a STA MLD may also communicate peer-to-peer with another STA MLD.

The AP MLDs 120 and the STA MLD 110 are generally representative of any device capable of performing multi-link operations. Here, each AP MLD 120 includes two APs (which may be referred to herein as “radios”). As illustrated, AP MLD 120-1 includes AP 115-1 and AP 115-2, AP MLD 120-2 includes AP 115-3 and AP 115-4, and AP MLD 120-3 includes AP 115-5 and AP 115-6. Similarly, STA MLD 110 includes two STAs 105-1 and 150-2 (which may be referred to herein as “radios”). Although each AP MLD 120 is depicted as including two APs, it should be noted that each AP MLD 120 may include any number of APs. Similarly, while STA MLD 110 is depicted with two STAs, it should be noted that the STA MLD may include any number of STAs.

As used herein, the term “radio” may refer to the capability to connect to a peer device on a link. Thus, by way of example, the two APs 115-1 and 115-2, as depicted within AP MLD 120-1, may represent either two physical radios or two logical radios enabled by a single physical radio (which is capable of being used on two different links in a time-switched fashion). Similarly, the two STAs 105-1 and 150-2, as depicted within STA MLD 110, may represent either two physical radios or two logical radios enabled by a single physical radio (which is capable of being used on two different links in a time-switched fashion).

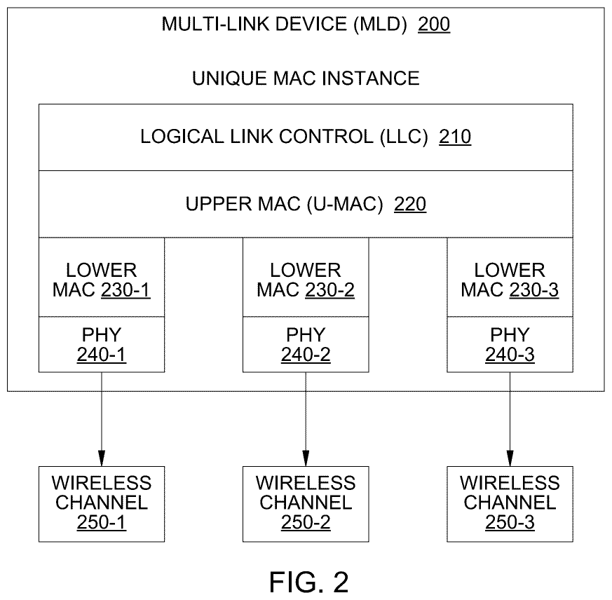

FIG. 2 illustrates an example architecture of a MLD 200, according to certain embodiments. The MLD 200 may be an AP MLD 120 or a STA MLD 110. As depicted in FIG. 2, the MLD 200 provides a unique MAC instance to multiple wireless interfaces (e.g., wireless channels 250 1-N), each of which may be utilized by a respective “radio” (e.g., AP 115 or STA 105). The MLD 200 includes a logical link control (LLC) layer 210 and an upper MAC (U-MAC) layer 220. The upper MAC layer 220 is a common part of the MAC sub-layer for all the interfaces (e.g., wireless channels 250 1-N). The MLD 200 also includes a respective lower MAC (L-MAC) 230 1-N for each interface. Each respective L-MAC 230 manages a corresponding physical (PHY) layer 240 as well as link specific functionalities (e.g., channel access) for the corresponding wireless channel 250 (e.g., link).

A MLD may generally be classified based on whether it is a single radio MLD or multi-radio MLD. Single radio MLDs generally use a single radio to switch between one or more links. One category of single radio MLDs is Enhanced Multi-Link Single Radio (eMLSR). eMLSR devices generally operate one main wireless radio that can transmit and/or receive data frames on a given link, but can detect some data (e.g., short initial frames) on a set of other links when the device is not actively transmitting or receiving. Multi-radio MLDs may generally be classified into the following two types: (i) simultaneous transmission and reception (STR) MLD and (ii) non-STR MLD. For STR MLDs, a transmission on one link may not affect the operations of frame reception and clear channel assessment (CCA) on other links. Stated differently, for STR MLDs, individual links can operate independently of each other. For non-STR MLDs, operation on one link may be restricted by operation on another link. For example, a transmission on one link may not be allowed if it will cause reception interruption on another link. In another example, a reception or CCA on one link may not be allowed if a transmission is ongoing on another link.

Referring back to FIG. 1, in certain embodiments, the AP MLDs 120 may be controlled or managed at least partially by the controller 130. Here, the controller 130 couples to and provides coordination and control for the AP MLDs 120 1-3. For example, the controller 130 may handle adjustments to RF power, channels, authentication, and security for the AP MLDs 120. The controller 130 may also coordinate the links formed by the AP MLDs 120. In certain embodiments, the controller 130 may also control, manage, and/or coordinate AP MLD power save operations for the AP MLDs 120 1-3, including, for example, AP MLD power save schedules, such as planned schedules and impromptu schedules. Each AP MLD 120 may maintain a respective connection to the DS 140, which may be configured to manage client roaming across multiple AP MLDs within the SMD 170 and/or ESS 160. In certain embodiments, the DS 140 may include or otherwise be implemented by the controller 130.

The operations of the controller 130 may be implemented by any device or system, and may be combined or distributed across any number of systems. For example, the controller 130 may be a WLAN controller for the deployment of AP MLDs 120 within the system 100. In some examples, the controller 130 is included within or integrated with an AP MLD 120 and coordinates the links formed by that AP 120 (or otherwise provides control for that AP MLD). For example, each AP MLD 120 may include a controller that provides control for that AP MLD. In some embodiments, the controller 130 is separate from the AP MLDs 120 and provides control for those AP MLDs. In FIG. 1, for example, the controller 130 may communicate with the AP MLDs 120 1-3 via a (wired or wireless) backhaul. The AP MLDs 120 1-3 may also communicate with one another, e.g., directly or indirectly via a wireless or wireline backhaul. The database(s) 172 are representative of storage systems that may include, without limitation, radio resource configurations, radio resource management (RRM) information, AP MLD power save schedules, among other information.

In certain embodiments, the system 100 is representative of a seamless roaming architecture. Within system 100, seamless roaming is enabled within the SMD 170. The SMD 170 includes multiple AP MLDs 120 across which seamless roaming is supported, extending the fast basic service set (BSS) transition (FT) mobility domain (MD) defined in IEEE 802.11r. In certain embodiments, the SMD 170 covers all AP MLDs of an ESS (e.g., ESS 160). In other embodiments, the ESS 160 may include multiple SMDs.

In certain embodiments, each SMD (e.g., SMD 170) is uniquely identified in the ESS 160 with a virtual MAC address, referred to herein as an SMD MAC address (or SMD MLD identifier (MDMI)). Each AP MLD 120 may be configured with the identifier of the SMD (e.g., SMD MAC address) that the AP MLD 120 belongs to. In FIG. 1, for example, AP MLDs 120 1-3 may each be configured with the SMD MAC address associated with SMD 170. The respective APs 115 associated with each AP MLD 120 may advertise SMD information (for that AP MLD 120) in beacon frames transmitted by the APs 115.

In certain embodiments, the SMD 170 defines a single security domain where all AP MLDs 120 within the SMD 170 are trusted (and in the same ESS 160). In such embodiments, a client STA 110 can establish a single secure association with this trusted security domain, and all AP MLDs 120 of the SMD 170 can be configured to have the same set of cryptographic encryption key (e.g., same set of cipher suites). To achieve seamless roaming, the STA MLD 110 (or non-AP MLD) can initially associate with the SMD 170 through one of the AP MLDs 120 (e.g., AP MLD 120-1 within the SMD 170). The STA MLD 110 may maintain its association and security context associated with the SMD 170 as it roams within the SMD 170, e.g., to avoid reauthentication, reassociation, and rekeying delays. For example, as the STA MLD 110 moves away from AP MLD 120-1, the STA MLD 110 may roam to one or more other AP MLDs 120-2 and 120-3.

As noted, in certain embodiments, one or more of the AP MLDs 120-1 to 120-3 may perform an AP MLD power save operation, e.g., to save power and minimize energy consumption within the wireless network (e.g., ESS 160). In such embodiments, a given AP MLD that plans to perform an AP MLD power save operation may send an AP power save notification (announcing or notifying the AP MLD's upcoming AP MLD power save operations) to allow STA MLDs to determine whether to associate to, or remain associated with, the AP MLD.

Additionally, in certain embodiments, a given AP MLD that plans to perform an AP MLD power save operation may assist with the transfer of setup links of STA MLDs that are still associated with the AP MLD to one or more neighboring AP MLDs, to facilitate the seamless transition of communication for those STA MLDs. By way of example, with reference to FIG. 1, the AP MLD 120-1 may assist with setting up links 3 and 4 on the AP MLD 120-2, e.g., in response to determining that STA MLD 110 is still connected (or associated with) the AP MLD 120-1 within a predetermined amount of time of performing an AP MLD power save operation. In some cases, link 3 may have similar parameters/communication metrics as link 1, and link 4 may have similar parameters/communication metrics as link 2. For example, if link 1 is a 2.4 GHz link, then link 3 may be a 2.4 GHz link. Likewise, if link 2 is a 5 GHz link or 6 GHz link, then link 4 may be a 5 GHz link or 6 GHz link.

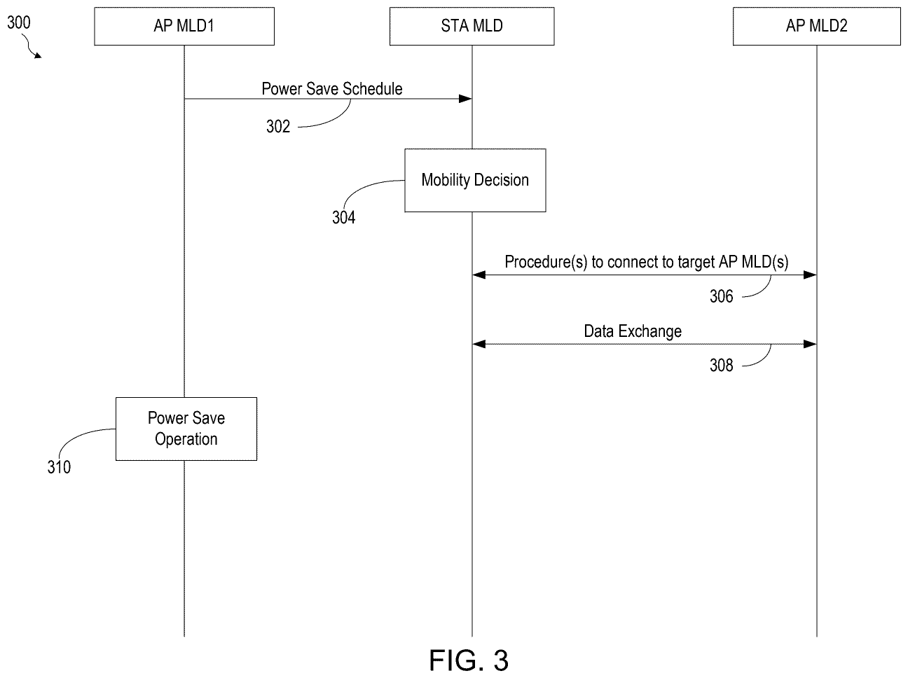

FIG. 3 illustrates an example call flow 300 for facilitating seamless transition of communications within a wireless network (e.g., ESS 160) during AP MLD power save operations, according to certain embodiments. Here, the call flow 300 depicts example operations by one or more of an AP MLD1 (e.g., AP MLD 120-1), a STA MLD (e.g., STA MLD 110), and an AP MLD2 (e.g., AP MLD 120-2, AP MLD 120-3, etc.).

In certain embodiments, assuming an AP MLD power save operation is planned in advance and is known (e.g., the AP MLD1 has a planned power down between 8 PM-6 AM), then the AP MLD1 may advertise its power save schedule to one or more STA MLDs within the wireless network. The power save schedule may include an indication of one or more time periods when the AP MLD1 will perform (or undergo) an AP MLD power save operation. The AP MLD power save operation may involve powering off the entire AP MLD, powering off a subset of links of the AP MLD, reducing power to the entire AP MLD, reducing power of a subset of links of the AP MLD, operating the AP MLD at a reduced capability (e.g., the AP MLD may support a reduced number of capabilities compared to when the AP MLD is not operating at a reduced capability), or operating a subset of links of the AP MLD at a reduced capability. The capabilities of an AP MLD may include multi-band operation, link aggregation, dynamic link selection, enhanced throughput, low latency, strict scheduling requirement (STR), among others. At step 302, for example, the AP MLD1 sends an AP power save schedule to the STA MLD.

The AP MLD1 may send the AP power save schedule using any of various types of management frames, including broadcast management frames, multicast management frames, and unicast management frames, as illustrative examples. In certain embodiments, the AP MLD1 may send the AP power save schedule via one or more information elements (IEs) in a beacon frame broadcast by the AP MLD1 within the network. For example, certain embodiments may modify the target wake time (TWT) IE (or another IE) within a beacon frame to explicitly indicate a schedule of time periods when the AP MLD1 will perform (or undergo) an AP MLD power save operation. That is, as opposed to the TWT IE indicating time periods when the AP MLD1 will be awake, the TWT IE may be enhanced (or modified) to additionally or alternatively include a subelement that explicitly indicates the time periods when the AP MLD1 will be powered down or enter a reduced power state. Note, however, that the AP power save schedule may be indicated (or advertised) using other IEs within the beacon frame.

In certain embodiments, the AP MLD1 may send the AP power save schedule in a probe response frame. For example, the probe response frame may be enhanced (or modified) to include (or otherwise indicate) the AP power save schedule. For instance, the AP MLD1 may send the AP power save schedule (including an explicit indication of a schedule of time periods when the AP MLD1 will perform (or undergo) an AP MLD power save operation) in a probe response frame, in response to a probe request frame received from the STA MLD. The probe request frame may or may not include a request for an AP power save schedule.

In certain embodiments, the AP MLD1 may send the AP power save schedule in a (re)association response frame. For example, the (re)association response frame may be enhanced (or modified) to include (or otherwise indicate) the AP power save schedule. For instance, the AP MLD1 may send the AP power save schedule (including an explicit indication of a schedule of time periods when the AP MLD1 will perform (or undergo) a planned AP MLD power save operation) in a (re)association response frame, in response to a (re)association request frame received from the STA MLD. The (re)association request frame may or may not include a request for an AP power save schedule.

In general, the AP MLD1 may send the AP power save schedule in any of various management frames, including beacon frames, probe response frames, multilink probe response frames, (re)association response frames, and operating mode notification frames, as illustrative, non-limiting examples. In certain embodiments, the management frame may be enhanced (or modified) to include (or otherwise indicate) the AP power save schedule (e.g., via an IE). For example, one or more of the management frames may be modified to include an IE that indicates the AP power save schedule or an existing IE may be modified to include the AP power save schedule. Examples of such IEs include a reconfiguration multilink (ML) IE, a basic ML element, a TWT element, and an operating mode notification element, as illustrative examples.

Note, in some cases, the AP MLD1 may send the AP power save schedule (e.g., at step 302) to indicate an unplanned (and perhaps one time) AP MLD power save operation, assuming the unplanned AP MLD power save operation is known in advance by the AP MLD1.

At step 304, the STA MLD may make a mobility decision based on the AP power save schedule received from the AP MLD1. For example, the mobility decision may include a determination of whether to (re) associate with the AP MLD1 (assuming the STA MLD is not initially or currently associated with the AP MLD1). In another example, the mobility decision may include a determination of whether to remain associated with the AP MLD1 or roam to another AP MLD, such as AP MLD2.

In certain embodiments, the STA MLD may determine, at step 304, to connect with AP MLD2, based on the AP power save schedule. For example, the AP power save schedule may indicate that the AP MLD1 is planning to perform an AP MLD power save operation within a threshold amount of time, and the STA MLD may determine to connect to another AP MLD to avoid losing connectivity due to the AP MLD power save operation. As illustrated at step 306, the STA MLD and AP MLD2 may perform one or more procedures in order to allow the STA MLD to connect to the AP MLD2. In some cases, the STA MLD may (re) associate with the AP MLD2 (e.g., via a (re) association request/response frame exchange) and (re) authenticate with the AP MLD2 (e.g., via a (re)authentication request/response frame exchange) (e.g., assuming the AP MLD2 is not included within an SMD (e.g., SMD 170)). In other cases, assuming the AP MLD2 is included within an SMD, the STA MLD may be initially associated with the SMD and may roam to the AP MLD2 while remaining associated with the SMD and without performing (re) association and (re) authentication, e.g., with the AP MLD2.

At step 308, the STA MLD and AP MLD2 may perform a data exchange. At step 310, the AP MLD1 may perform a power save operation, e.g., in accordance with the AP power save schedule. Here, the power save operation may occur after the STA MLD has connected with the AP MLD2.

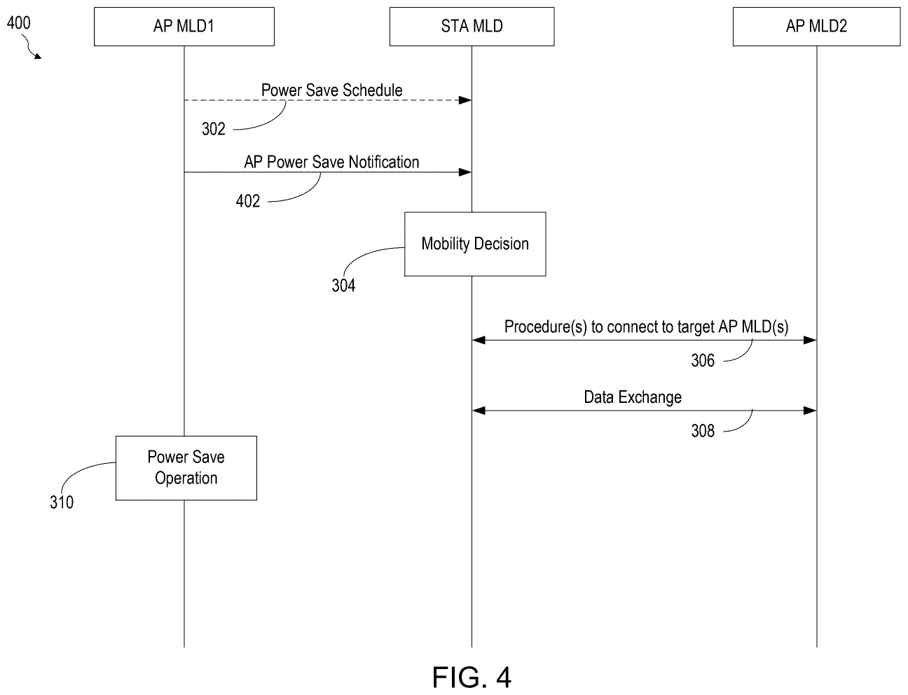

FIG. 4 illustrates an example call flow 400 for facilitating seamless transition of communications within a wireless network (e.g., ESS 160) during AP MLD power save operations, according to certain embodiments. Here, the call flow 400 depicts example operations by one or more of an AP MLD1 (e.g., AP MLD 120-1), a STA MLD (e.g., STA MLD 110), and an AP MLD2 (e.g., AP MLD 120-2, AP MLD 120-3, etc.). Note, one or more of the steps 302, 304, 306, 308, and 310 depicted in call flow 400 may be similar to one or more of the steps 302, 304, 306, 308, and 310, respectively, depicted in call flow 300. Accordingly, for the sake of clarity, such steps may not be described again.

Compared to call flow 300, at step 402 in call flow 400, the AP MLD1 may transmit an AP MLD power save notification to indicate an upcoming (planned or impromptu) AP MLD power save operation. For example, in some cases, the STA MLD may not have received the AP power save schedule of AP MLD1 (in step 302). This failure may be due to various factors, such as the AP MLD1 failing to transmit the AP power save schedule (e.g., the AP MLD1 may be undergoing an impromptu AP MLD power save operation), the frame (including the AP power save schedule) being dropped or colliding with other frames (e.g., due to interference on the wireless channel), and/or the STA MLD being in a power-off state or reduced power mode when the AP power save schedule was transmitted, as illustrative examples. Accordingly, in such cases, the AP MLD1 may (in addition to, or as an alternative to, transmitting the AP power save schedule) transmit an AP MLD power save notification to indicate the upcoming AP MLD power save operation.

The AP MLD1 may send the AP MLD power save notification using any of various types of management frames. In certain embodiments, the AP MLD1 may send the AP MLD power save notification via one or more IEs in a beacon frame (or another type of broadcast frame) broadcast by the AP MLD1. In certain embodiments, the AP MLD1 may advertise in the beacon frame (or another type of broadcast frame) that the AP MLD1 may perform the AP MLD power save operation in a certain number of target beacon transmission times (TBTTs). In certain embodiments, the reconfiguration multi- link (ML) IE (or another IE) within a beacon frame (or another type of broadcast frame) may be modified to indicate (i) an amount of time remaining before the AP MLD1 performs an AP MLD power save operation, (ii) a duration of the AP MLD power save operation, or (iii) any combination thereof. For example, the reconfiguration ML IE (or another IE) within the (common info field) of the beacon frame (or another type of broadcast frame) may be modified to include an AP MLD removal timer for the entire AP MLD1, a duration field indicating a duration of the AP MLD power save operation, or any combination thereof. The AP MLD removal timer may be set to the number of TBTTs after which the AP MLD1 will perform (or undergo) the AP MLD power save operation. The duration field may be set to the number of TBTTs after which the AP MLD1 will exit from the AP MLD power save operation.

In certain embodiments, the reconfiguration ML IE (or another IE) within a beacon frame (or another type of broadcast frame) may be modified to indicate (i) a respective AP MLD removal timer for each AP (e.g., AP 115) within the APMLD1 and (ii) a duration of the AP MLD power save operation. In certain embodiments, the AP MLD1 may send the AP MLD power save notification using one or more unicast frames, such as a BSS transition management (BTM) request frame, probe response frame, among others.

In general, the AP MLD1 may send the AP MLD power save notification in any of various management frames, including beacon frames, probe response frames, BTM request frames, multilink probe response frames, (re)association response frames, and operating mode notification frames, as illustrative, non-limiting examples. In certain embodiments, the management frame may be enhanced (or modified) to include (or otherwise indicate) the AP MLD power save notification (e.g., via an IE). For example, one or more of the management frames may be modified to include an IE that indicates the AP MLD power save notification or an existing IE may be modified to include the AP MLD power save notification. Examples of such IEs include a reconfiguration ML IE, a basic ML element, a TWT element, and an operating mode notification element, as illustrative examples.

As noted, in some cases, after an AP MLD has indicated an upcoming AP MLD power save operation (e.g., via an AP power save schedule and/or AP MLD power save notification), some STA MLDs may still be connected to the AP MLD within a threshold period of time of the AP MLD performing the AP MLD power save operation. In such cases, certain embodiments described herein provide techniques for enabling the AP MLD to coordinate with one or more neighboring AP MLDs to transfer setup links for such STA MLDs to one or more of the neighboring AP MLDs. Doing so may reduce the likelihood of interrupting the STA MLD's communication due to the AP MLD power save operation. Note, the techniques described herein for transferring setup links for a STA MLD(s) to one or more neighboring AP MLDs may be performed when the STA MLD(s) is not required to perform a reassociation with the neighboring AP MLD(s). That is, the AP MLD as well as the neighboring AP MLDs should belong to a same SMD (e.g., SMD 170).

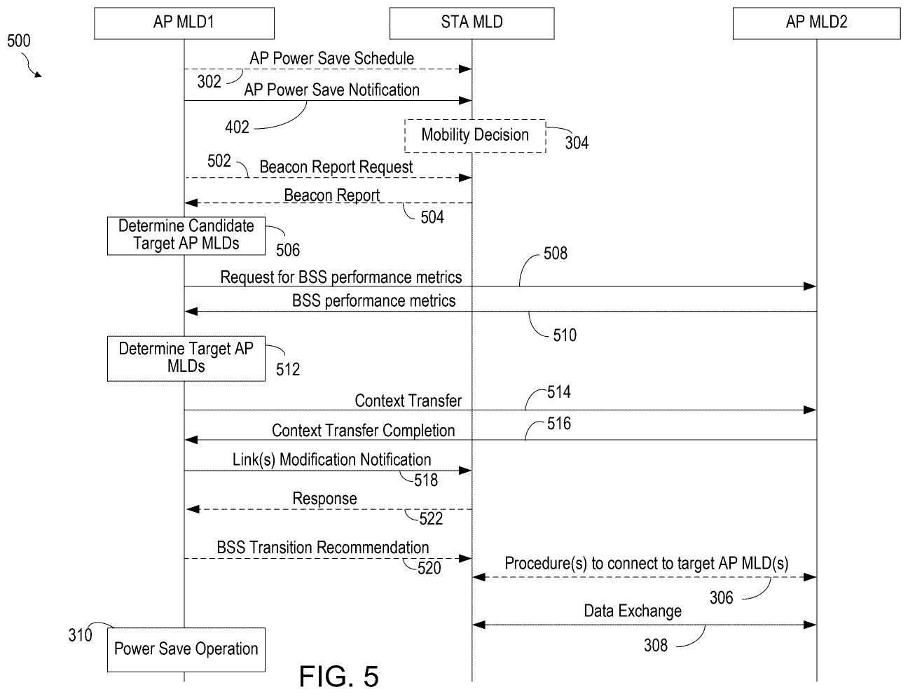

FIG. 5 illustrates an example call flow 500 for facilitating seamless transition of communications within a wireless network (e.g., ESS 160) during AP MLD power save operations, according to certain embodiments. Here, the call flow 500 depicts example operations by one or more of an AP MLD1 (e.g., AP MLD 120-1), a STA MLD (e.g., STA MLD 110), and an AP MLD2 (e.g., AP MLD 120-2, AP MLD 120-3, etc.). Note, one or more of the steps 302, 304, 306, 308, 310, and 402 depicted in call flow 500 may be similar to one or more of the steps 302, 304, 306, 308, 310, and 402 respectively, depicted in call flow 400. Accordingly, for the sake of clarity, such steps may not be described again.

Compared to call flow 300 and call flow 400, in call flow 500, the STA MLD may still be connected with the AP MLD1 within a threshold amount of time of the AP MLD power save operation for AP MLD1, after the AP MLD1 transmits the AP power save schedule (at step 302) and the AP MLD power save notification (at step 402). Accordingly, the AP MLD1 may determine to facilitate the transfer of setup links for the STA MLD to AP MLD2.

In certain embodiments, the AP MLD1 may request beacon reports from all STA MLDs connected to the AP MLD1. As shown at step 502, the AP MLD1 transmits a beacon report request to the STA MLD, and at step 504, the STA MLD provides a beacon report to the AP MLD1. At step 506, the AP MLD1 determines a set of possible candidate target AP MLDs on which to set up links for the STA MLD, based at least in part on the received beacon report(s). Here, for example, the AP MLD1 may determine AP MLD2 as a possible candidate target AP MLD on which to set up links for the STA MLD.

In certain embodiments, the AP MLD1 may request certain BSS performance metrics from the candidate target AP MLDs. The BSS performance metrics may include, for example, BSS load information, BSS latency information (e.g., 90^{th} percentile latency observed), among other performance metrics. As shown at step 508, the AP MLD1 requests BSS performance metrics from the AP MLD2, and at step 510, the AP MLD2 provides the BSS performance metrics to the AP MLD1.

Using the BSS performance metrics, the capabilities of the STA MLD, and the stream classification service (SCS)/TWT flows established for the STA MLD, the AP MLD1 may determine (from the candidate target AP MLDs) one or more target AP MLDs which are part of the same SMD as AP MLD1, where the AP MLD1 wants to set up links on for the STA MLD. Here, for example, at step 512, the AP MLD1 determines AP MLD2 as a target AP MLD, based on the BSS performance metrics, the capabilities of the STA MLD, and the SCS/TWT flows established for the STA MLD. Note, while FIG. 5 describes the AP MLD2 as both the candidate target AP MLD and the target AP MLD, it should be noted that the AP MLD1 (at step 512) may determine a subset of the candidate target AP MLDs (determined at step 506) as the target AP MLDs. Note, the target AP MLDs determined at step 506 may be a part of the same SMD as AP MLD1.

After determining the target AP MLDs (e.g., AP MLD2), the AP MLD1 may determine to set up links for all connected STA MLDs (e.g., STA MLD) on the same neighboring AP MLD (e.g., AP MLD2) or determine to set up links for one or more connected STA MLDs on multiple neighboring AP MLDs (e.g., AP MLD2, AP MLD3 (not shown), AP MLD4 (not shown), etc.). Referring back to FIG. 1, in an illustrative example, the AP MLD1 may determine to set up a link 3 on AP MLD2 for the STA MLD and to set up a link 4 on the AP MLD2 for the STA MLD. Link 3 may have similar parameters/metrics as link 1 between STA MLD and AP MLD1 and link 4 may have similar parameters/metrics as link 2 between STA MLD and AP MLD1.

The AP MLD1 may then perform a context transfer for STA MLD(s) connected to the AP MLD1 to one or more selected neighboring AP MLDs (e.g., transferring a context for the STA MLD(s) to the one or more selected neighboring AP MLDs). As shown at 514, for example, the AP MLD1 performs a context transfer for the STA MLD to the AP MLD2. The AP MLD1 may perform the context transfer via AP-to-AP communication. The AP-to-AP communication for the context transfer may involve a batch context transfer. The context that is transferred may include a dynamic data exchange context (e.g., sequence number (SN) and packet number (PN) context) and other less dynamic context, such as security context (pairwise master key (PMK), pairwise transient key (PTK)), SCS, TWT, block acknowledgment (BA) agreements and capabilities, as illustrative examples. The neighboring AP MLD (e.g., AP MLD2), after receiving the context transfer information, may initiate the DS mapping update for the STA MLD. The neighboring AP MLD (e.g., AP MLD2) sends a response to the AP MLD (being powered down) (e.g., AP MLD1) to signal completion of the context transfer (step 516).

After receiving indication of completion of the context transfer, the AP MLD1 may transmit a link(s) modification notification to the STA MLD (step 518). For example, the AP MLD may send a link reconfiguration notify frame (or another equivalent management frame) (as the link(s) modification notification) to each of the STA MLDs for which the context transfer successfully completed. This frame indicates, to the STA MLD, at least one of (i) the set of links which have been set up on the neighboring AP MLD for that STA MLD, (ii) the context of the STA MLD that was transferred to the neighboring AP MLD as part of the context transfer, or (iii) that the link(s) with the current AP MLD will be removed. In certain embodiments, the link reconfiguration notify frame (or another equivalent management frame) can also provide an indication of a time period (or amount of time) during which the STA MLD can still retrieve downlink (DL) buffered MAC protocol data units (MPDUs) from the AP MLD1 before the AP MLD1 performs an AP MLD power save operation. In certain embodiments, the AP MLD1 (at step 518) can use DL orthogonal frequency-division multiple access (OFDMA) to send the link reconfiguration notify frame to multiple STA MLDs at the same time, to notify of transfer of setup links.

After transmitting the link(s) modification notification, the STA MLD can now start exchanging uplink (UL)/downlink (DL) data with the neighboring AP MLD(s) (e.g., AP MLD2) indicated in the received link(s) modification notification, and may continue to retrieve any DL data buffered on the current AP MLD (e.g., AP MLD1) (not shown), until the timeout indicated.

In certain embodiments, after receiving the link(s) modification notification, the STA MLD may transmit a response indicating a rejection of the links that have been set up for the STA MLD. In FIG. 5, for example, in response to the link(s) modification notification, the STA MLD (at step 522) transmits, to the AP MLD1, a response including a reject status for the link(s) set up for the STA MLD on the AP MLD2. After receiving the response at step 522, the AP MLD1 may remove the link(s) that have been set up on the AP MLD2 for the STA MLD.

In certain embodiments, for legacy (non-ultra-high reliability (UHR)) STAS and/or STA MLDs that do not support UHR seamless roaming and/or in cases when a neighboring AP MLD within the same SMD cannot be selected for UHR STA MLDs, a new association may be performed with the neighboring AP MLDs. The AP MLD (performing the AP MLD power save operations) can use a BTM mechanism (defined in IEEE 802.11) to recommend one or more neighboring AP MLDs for BSS transition. For example, as shown at 520 in call flow 500, the AP MLD1 can send a BSS transition recommendation to the STA MLD. The BSS transmission recommendation may include a “Disassociation Imminent” field set to ‘1’ to indicate imminent disassociation due to power down of the AP MLD1. The STA MLD can then (re) associate with one of BTM recommended neighboring AP MLDs (e.g., AP MLD2) using a (re)association procedure and (re)authentication procedure, e.g., at step 306.

Advantageously, the aforementioned embodiments define mechanisms to achieve seamless transition of STA MLDs for AP MLD power save scenarios due to AP MLD power down, by including advertisement of AP MLD power down and seamless transfer of setup links to neighboring AP MLDs.

### Example Operations

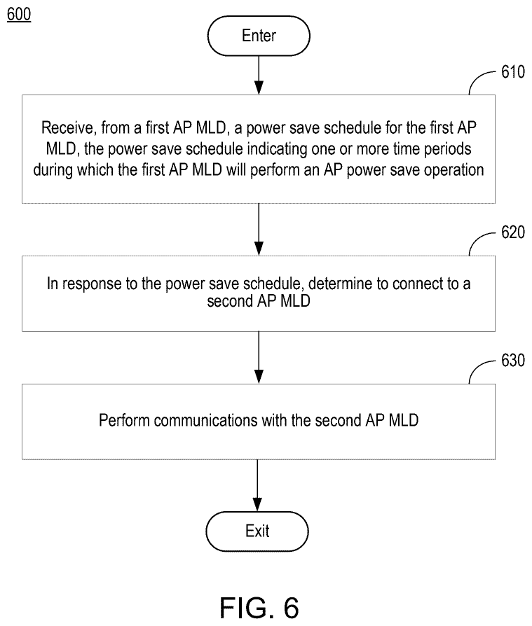

FIG. 6 is a flowchart of a method 600 for seamless transition of communications for a STA MLD during AP MLD power save operations, according to certain embodiments. The method 600 may be performed by a wireless device, such as a client (e.g., STA MLD 110).

Method 600 enters at block 610, where the client receives, from a first AP MLD, a power save schedule for the first AP MLD. The power save schedule indicates one or more time periods during which the first AP MLD will perform an AP power save operation.

At block 620, the client determines to connect to a second AP MLD, in response to the power save schedule. At block 630, the client performs communications with the second AP MLD.

In certain embodiments, the method 600 further involves receiving, from the first AP MLD, an AP power save notification for the first AP MLD. The AP power save notification indicates an amount of time after which the first AP MLD will perform the AP power save operation.

In certain embodiments, receiving the AP power save notification includes receiving a management frame comprising the AP power save notification.

In certain embodiments, the management frame includes a beacon frame, a basic service set transition management (BTM) request frame, a probe response frame, a multilink probe response frame, an operating mode notification frame, or a (re)association response frame.

In certain embodiments, the management frame includes an information element comprising the AP power save notification. The information element may include a reconfiguration ML element, a basic multilink element, a target wake time element, or an operating mode notification element.

In certain embodiments, receiving the power save schedule includes receiving a management frame comprising the power save schedule. The management frame may include a beacon frame, a probe response frame, a multilink probe response frame, an operating mode notification frame, or a (re)association response frame. In certain embodiments, the management frame includes an information element comprising the power save schedule. The information element may include a target wake time (TWT) information element, a reconfiguration multilink information element, or a basic multilink element.

In certain embodiments, the first AP MLD and the second AP MLD belong to a same seamless mobility domain (SMD) and wherein the client MLD is associated with the SMD.

In certain embodiments, the AP power save operation includes powering off the first AP MLD, powering off a set of links of the first AP MLD, reducing power to the first AP MLD, reducing power to the set of links of the first AP MLD, operating the first AP MLD at a reduce capability, or operating the set of links of the first AP MLD at a reduce capability.

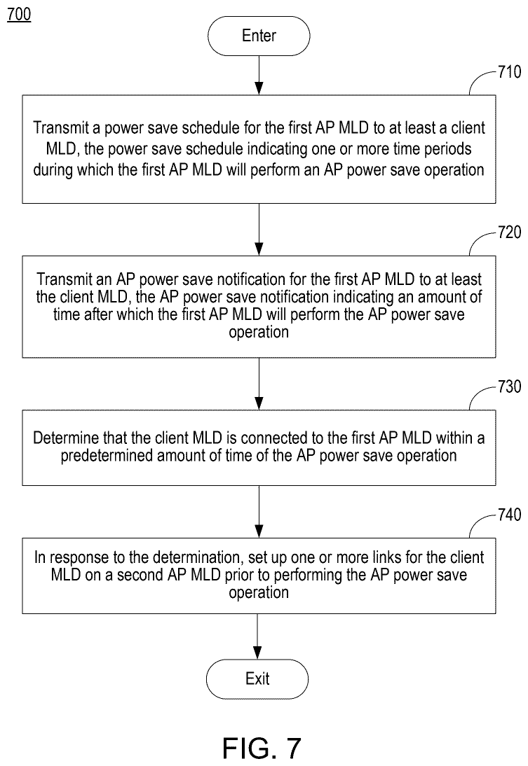

FIG. 7 is a flowchart of a method 700 for seamless transition of communications for a STA MLD during AP MLD power save operations, according to certain embodiments. The method 700 may be performed by a network entity, such as a (first) AP MLD (e.g., AP MLD 120).

Method 700 enters at block 710, where the first AP MLD transmits a power save schedule for the first AP MLD to at least a client MLD (e.g., STA MLD 110). The power save schedule indicates one or more time periods during which the first AP MLD will perform an AP power save operation.

At block 720, the first AP MLD transmits an AP power save notification for the first AP MLD to at least the client MLD. The AP power save notification indicates an amount of time after which the first AP MLD will perform the AP power save operation.

At block 730, the first AP MLD determines that the client MLD is connected to the first AP MLD within a predetermined amount of time of the AP power save operation.

At block 740, the first AP MLD, in response to the determination, sets up a first one or more links for the client MLD on a second AP MLD prior to performing the AP power save operation.

In certain embodiments, transmitting the power save schedule includes transmitting a management frame comprising the power save schedule.

In certain embodiments, transmitting the AP power save notification includes transmitting a management frame comprising the AP power save notification.

In certain embodiments, setting up the first one or more links includes: determining a set of candidate target AP MLDs on which to set up the first one or more links for the client MLD; determining, from the set of candidate target AP MLDs, the second AP MLD as a target AP MLD on which to set up the first one or more links for the client MLD, based at least in part on one or more performance metrics associated with the set of candidate target AP MLDs and a second one or more links that the client MLD has set up with the first AP MLD; and performing a context transfer for the client MLD to the second AP MLD. The second AP MLD may be part of a same SMD as the first AP MLD.

In certain embodiments, setting up the first one or more links further includes transmitting, to the client MLD, an indication of at least one of (i) the first one or more links set up on the second AP MLD for the client MLD, (ii) a context of the client MLD that was transferred to the second AP MLD as part of the context transfer, or (iii) an amount of time during which the client MLD can retrieve downlink data from the first AP MLD prior to the AP power save operation. In certain embodiments, method 700 further includes: receiving, from the client MLD, a reject status in response to transmitting the indication; and removing the first one or more links that have been set up on the second AP MLD for the client MLD.

In certain embodiments, the AP power save operation includes powering off the first AP MLD, powering off a set of links of the first AP MLD, reducing power to the first AP MLD, reducing power to the set of links of the first AP MLD, operating the first AP MLD at a reduced capability, or operating the set of links of the first AP MLD at a reduced capability.

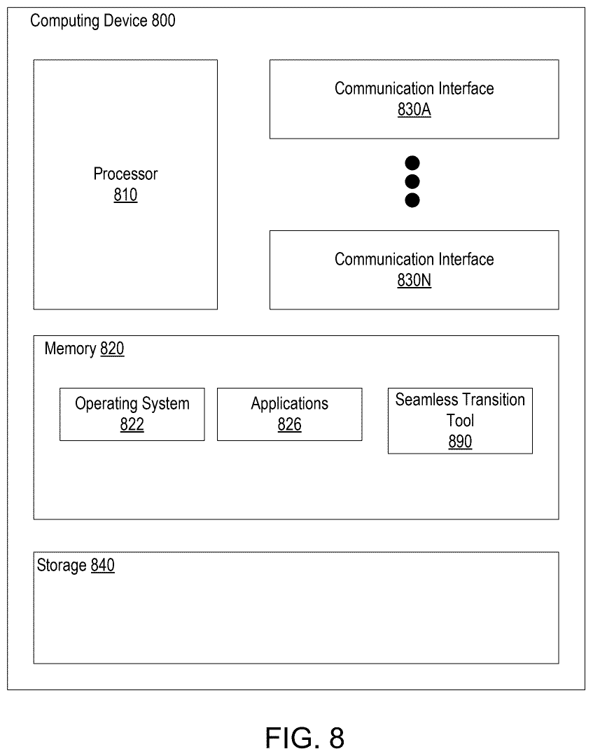

FIG. 8 illustrates an example computing device 800, according to one embodiment. The computing device 800 can be configured to perform one or more techniques described herein for facilitating seamless transition of communications for a STA MLD during AP MLD power save operations. For example, the computing device 800 can perform method 600, method 700, and any other techniques (or combination of techniques) described herein. The computing device 800 may be representative of a controller (e.g., controller 130), a network entity (e.g., an AP MLD, such as AP MLD 120), or a wireless device (e.g., STA MLD 110). The computing device 800 includes, without limitation, a processor 810, a memory 820, and one or more communication interfaces 830a-n (generally, communication interface 830). In one example, the communication interface 830 includes a radio.

The processor 810 may be any processing element capable of performing the functions described herein. The processor 810 represents a single processor, multiple processors, a processor with multiple cores, and combinations thereof. The communication interfaces 830 (e.g., radios) facilitate communications between the computing device 800 and other devices. The communications interfaces 830 are representative of wireless communications antennas and various wired communication ports.

The memory 820 may be either volatile or non-volatile memory and may include RAM, flash, cache, disk drives, and other computer readable memory storage devices. Although shown as a single entity, the memory 820 may be divided into different memory storage elements such as RAM and one or more hard disk drives. As shown, the memory 820 includes various instructions that are executable by the processor 810 to provide an operating system 822 to manage various functions of the computing device 800. The memory 820 also includes seamless transition tool 890 and one or more application(s) 826. The seamless transition tool 890 may be configured to perform method 600, method 700, and/or any combination of techniques described herein.

The computing device 800 may include storage (not shown). In some cases, the storage may be a disk drive or flash storage device. In some cases, the storage may be a combination of fixed and/or removable storage devices, such as fixed disc drives, solid state drives, removable memory cards, optical storage, network attached storage (NAS), or a storage area-network (SAN).

### Example Clauses

Implementation examples are described in the following numbered clauses:

Clause 1: A computer-implemented method for wireless communications performed by a client multilink device (MLD), the computer-implemented method comprising: receiving, from a first access point (AP) MLD, a power save schedule for the first AP MLD, the power save schedule indicating one or more time periods during which the first AP MLD will perform an AP power save operation; in response to the power save schedule, determining to connect to a second AP MLD; and performing communications with the second AP MLD.

Clause 2: The computer-implemented method of Clause 1, further comprising receiving, from the first AP MLD, an AP power save notification for the first AP MLD, wherein the AP power save notification indicates an amount of time after which the first AP MLD will perform the AP power save operation.

Clause 3: The computer-implemented method of Clause 2, wherein receiving the AP power save notification comprises receiving a management frame comprising the AP power save notification.

Clause 4: The computer-implemented method of Clause 3, wherein the management frame comprises a beacon frame, a basic service set transition management (BTM) request frame, a probe response frame, a multilink probe response frame, a (re)association response frame, or an operating mode notification frame.

Clause 5: The computer-implemented method in accordance with any of Clauses 3-4, wherein the management frame comprises an information element comprising the AP power save notification.

Clause 6: The computer-implemented method of Clause 5, wherein the information element comprises a reconfiguration multilink information element, a basic multilink element, a target wake time (TWT) element, or an operating mode notification element.

Clause 7: The computer-implemented method in accordance with any of Clauses 1-6, wherein receiving the power save schedule comprises receiving a management frame comprising the power save schedule.

Clause 8: The computer-implemented method of Clause 7, wherein the management frame comprises a beacon frame, a probe response frame, a multilink probe response frame, a (re)association response frame, or an operating mode notification frame.

Clause 9: The computer-implemented method in accordance with any of Clauses 7-8, wherein the management frame comprises an information element comprising the power save schedule.

Clause 10: The computer-implemented method of Clause 9, wherein the information element comprises a target wake time (TWT) information element, a reconfiguration multilink information element, or a basic multilink element.

Clause 11: The computer-implemented method in accordance with any of Clauses 1-10, wherein the first AP MLD and the second AP MLD belong to a same seamless mobility domain (SMD) and wherein the client MLD is associated with the SMD.

Clause 12: The computer-implemented method in accordance with any of Clauses 1-11, wherein the AP power save operation comprises powering off the first AP MLD, powering off a set of links of the first AP MLD, reducing power to the first AP MLD, reducing power to the set of links of the first AP MLD, operating the first AP MLD at a reduced capability, or operating the set of links of the first AP MLD at a reduced capability.

Clause 13: A computer-implemented method for wireless communications performed by a first access point (AP) multilink device (MLD), the computer-implemented method comprising: transmitting a power save schedule for the first AP MLD to at least a client MLD, the power save schedule indicating one or more time periods during which the first AP MLD will perform an AP power save operation; transmitting an AP power save notification for the first AP MLD to at least the client MLD, the AP power save notification indicating an amount of time after which the first AP MLD will perform the AP power save operation; determining that the client MLD is connected to the first AP MLD within a predetermined amount of time of the AP power save operation; and in response to the determination, setting up a first one or more links for the client MLD on a second AP MLD prior to performing the AP power save operation.

Clause 14: The computer-implemented method of Clause 13, wherein: transmitting the power save schedule comprises transmitting a management frame comprising the power save schedule.

Clause 15: The computer-implemented method in accordance with any of Clauses 13-14, wherein transmitting the AP power save notification comprises transmitting a management frame comprising the AP power save notification.

Clause 16: The computer-implemented method in accordance with any of Clauses 13-15, wherein setting up the first one or more links comprises: determining a set of candidate target AP MLDs on which to set up the first one or more links for the client MLD; determining, from the set of candidate target AP MLDs, the second AP MLD as a target AP MLD on which to set up the first one or more links for the client MLD, based at least in part on one or more performance metrics associated with the set of candidate target AP MLDs and a second one or more links that the client MLD has set up with the first AP MLD; and performing a context transfer for the client MLD to the second AP MLD.

Clause 17: The computer-implemented method in accordance with any of Clauses 13-16, wherein the second AP MLD is part of a same seamless mobility domain as the first AP MLD.

Clause 18: The computer-implemented method in accordance with any of Clauses 13-17, wherein setting up the first one or more links further comprises transmitting, to the client MLD, an indication of at least one of (i) the first one or more links set up on the second AP MLD for the client MLD, (ii) a context of the client MLD that was transferred to the second AP MLD as part of the context transfer, or (iii) an amount of time during which the client MLD can retrieve downlink data from the first AP MLD prior to the AP power save operation.

Clause 19: The computer-implemented method of Clause 18, further comprising: receiving, from the client MLD, a reject status in response to transmitting the indication; and removing the first one or more links that have been set up on the second AP MLD for the client MLD.

Clause 20: The computer-implemented method in accordance with any of Clauses 13-19, wherein the AP power save operation comprises powering off the first AP MLD, powering off a set of links of the first AP MLD, reducing power to the first AP MLD, reducing power to the set of links of the first AP MLD, operating the first AP MLD at a reduced capability, or operating the set of links of the first AP MLD at a reduced capability.

Clause 21: A computing device comprising: one or more memories collectively storing instructions; and one or more processors communicatively coupled to the one or more memories, the one or more processors being individually or collectively configured to execute the instructions to cause the computing device to perform a method in accordance with any of Clauses 1-12.

Clause 22: A non-transitory computer-readable medium comprising computer-executable code, which when executed by one or more processors of a computing device perform a method in accordance with any of Clauses 1-12.

Clause 23: An apparatus comprising means for performing a method in accordance with any of Clauses 1-12.

Clause 24: A computing device comprising: one or more memories collectively storing instructions; and one or more processors communicatively coupled to the one or more memories, the one or more processors being individually or collectively configured to execute the instructions to cause the computing device to perform a method in accordance with any of Clauses 13-20.

Clause 25: A non-transitory computer-readable medium comprising computer-executable code, which when executed by one or more processors of a computing device perform a method in accordance with any of Clauses 13-20.

Clause 26: An apparatus comprising means for performing a method in accordance with any of Clauses 13-20.

As used herein, “a processor,” “at least one processor,” or “one or more processors” generally refers to a single processor configured to perform one or multiple operations or multiple processors configured to collectively perform one or more operations. In the case of multiple processors, performance of the one or more operations could be divided amongst different processors, though one processor may perform multiple operations, and multiple processors could collectively perform a single operation. Similarly, “a memory,” “at least one memory,” or “one or more memories” generally refers to a single memory configured to store data and/or instructions or multiple memories configured to collectively store data and/or instructions.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. A computer-implemented method for wireless communications performed by a client multilink device (MLD), the computer-implemented method comprising:
receiving, from a first access point (AP) MLD, a power save schedule for the first AP MLD, the power save schedule indicating one or more time periods during which the first AP MLD will perform an AP power save operation;
in response to the power save schedule, determining to connect to a second AP MLD; and
performing communications with the second AP MLD.

2. The computer-implemented method of claim 1, further comprising receiving, from the first AP MLD, an AP power save notification for the first AP MLD, wherein the AP power save notification indicates an amount of time after which the first AP MLD will perform the AP power save operation.

3. The computer-implemented method of claim 2, wherein receiving the AP power save notification comprises receiving a management frame comprising the AP power save notification.

4. The computer-implemented method of claim 3, wherein the management frame comprises a beacon frame, a basic service set transition management (BTM) request frame, a probe response frame, a multilink probe response frame, a (re) association response frame, or an operating mode notification frame.

5. The computer-implemented method of claim 3, wherein the management frame comprises an information element comprising the AP power save notification.

6. The computer-implemented method of claim 5, wherein the information element comprises a reconfiguration multilink information element, a basic multilink element, a target wake time (TWT) element, or an operating mode notification element.

7. The computer-implemented method of claim 1, wherein receiving the power save schedule comprises receiving a management frame comprising the power save schedule.

8. The computer-implemented method of claim 7, wherein the management frame comprises a beacon frame, a probe response frame, a multilink probe response frame, a (re)association response frame, or an operating mode notification frame.

9. The computer-implemented method of claim 7, wherein the management frame comprises an information element comprising the power save schedule.

10. The computer-implemented method of claim 9, wherein the information element comprises a target wake time (TWT) information element, a reconfiguration multilink information element, or a basic multilink element.

11. The computer-implemented method of claim 1, wherein the first AP MLD and the second AP MLD belong to a same seamless mobility domain (SMD) and wherein the client MLD is associated with the SMD.

12. The computer-implemented method of claim 1, wherein the AP power save operation comprises powering off the first AP MLD, powering off a set of links of the first AP MLD, reducing power to the first AP MLD, reducing power to the set of links of the first AP MLD, operating the first AP MLD at a reduced capability, or operating the set of links of the first AP MLD at a reduced capability.

13. A computer-implemented method for wireless communications performed by a first access point (AP) multilink device (MLD), the computer-implemented method comprising:
transmitting a power save schedule for the first AP MLD to at least a client MLD, the power save schedule indicating one or more time periods during which the first AP MLD will perform an AP power save operation;
transmitting an AP power save notification for the first AP MLD to at least the client MLD, the AP power save notification indicating an amount of time after which the first AP MLD will perform the AP power save operation;
determining that the client MLD is connected to the first AP MLD within a predetermined amount of time of the AP power save operation; and
in response to the determination, setting up a first one or more links for the client MLD on a second AP MLD prior to performing the AP power save operation.

14. The computer-implemented method of claim 13, wherein:
transmitting the power save schedule comprises transmitting a first management frame comprising the power save schedule; and
transmitting the AP power save notification comprises transmitting a second management frame comprising the AP power save notification.

15. The computer-implemented method of claim 13, wherein setting up the first one or more links comprises:
determining a set of candidate target AP MLDs on which to set up the first one or more links for the client MLD;
determining, from the set of candidate target AP MLDs, the second AP MLD as a target AP MLD on which to set up the first one or more links for the client MLD, based at least in part on one or more performance metrics associated with the set of candidate target AP MLDs and a second one or more links that the client MLD has set up with the first AP MLD; and
performing a context transfer for the client MLD to the second AP MLD.

16. The computer-implemented method of claim 15, wherein the second AP MLD is part of a same seamless mobility domain as the first AP MLD.

17. The computer-implemented method of claim 15, wherein setting up the first one or more links further comprises transmitting, to the client MLD, an indication of at least one of (i) the first one or more links set up on the second AP MLD for the client MLD, (ii) a context of the client MLD that was transferred to the second AP MLD as part of the context transfer, or (iii) an amount of time during which the client MLD can retrieve downlink data from the first AP MLD prior to the AP power save operation.

18. The computer-implemented method of claim 17, further comprising:
receiving, from the client MLD, a reject status in response to transmitting the indication; and
removing the first one or more links that have been set up on the second AP MLD for the client MLD.

19. The computer-implemented method of claim 13, wherein the AP power save operation comprises powering off the first AP MLD, powering off a set of links of the first AP MLD, reducing power to the first AP MLD, reducing power to the set of links of the first AP MLD, operating the first AP MLD at a reduced capability, or operating the set of links of the first AP MLD at a reduced capability.

20. A first access point (AP) multilink device (MLD) comprising:
one or more memories collectively storing instructions; and
one or more processors communicatively coupled to the one or more memories, the one or more processors being individually or collectively configured to execute the instructions to cause the first AP MLD to perform an operation comprising:
transmitting a power save schedule for the first AP MLD to at least a client MLD, the power save schedule indicating one or more time periods during which the first AP MLD will perform an AP power save operation;
transmitting an AP power save notification for the first AP MLD to at least the client MLD, the AP power save notification indicating an amount of time after which the first AP MLD will perform the AP power save operation;
determining that the client MLD is connected to the first AP MLD within a predetermined amount of time of the AP power save operation; and
in response to the determination, setting up one or more links for the client MLD on a second AP MLD prior to performing the AP power save operation.
